(19) United States
(12) Patent Application Publication
(10) Pub. No.: US 2025/0382765 A1
(43) Pub. Date: Dec. 18, 2025

(54) LIFTING AND RESETTING METHOD FOR SINKING OF DEEP PLANT EQUIPMENT FOUNDATION

(71) Applicant: BEIJING HENGXIANG HONGYE FOUNDATION REINFORCEMENT TECHNOLOGY CO., LTD., Beijing (CN)

(72) Inventor: Tengyue CUI, Beijing (CN)

(73) Assignee: BEIJING HENGXIANG HONGYE FOUNDATION REINFORCEMENT TECHNOLOGY CO., LTD., Beijing (CN)

(21) Appl. No.: 19/315,841

(22) Filed: Sep. 1, 2025

Related U.S. Application Data
(63) Continuation of application No. PCT/CN2023/086180, filed on Apr. 4, 2023.

(30) Foreign Application Priority Data
Mar. 2, 2023 (CN) 2023102256740

(51) Int. Cl. E02D 3/12; E02D 27/10; E02D 27/34

(52) U.S. Cl. CPC E02D 3/12; E02D 27/10; E02D 27/34

(57) ABSTRACT

The present application relates to a lifting and resetting method for sinking of a deep plant equipment foundation, and belongs to the technical field of anti-settlement and deviation rectification of foundations. The lifting and resetting method includes: determining a foundation pressure diffusion angle; determining a diffusion range of a load; performing grouting reinforcement on an unstable soil body in the soft underlying stratum; performing grouting reinforcement on a bearing stratum; performing grouting, reinforcing and lifting within a middle range of the bearing stratum; and constructing irregular composite foundation supporting bodies at the bottom of the soft underlying stratum. The lifting and resetting method of the present application can ensure a deviation rectification effect.

### CROSS-REFERENCE TO RELATED APPLICATIONS

The application claims priority to Chinese patent application No. 2023102256740, filed on Mar. 2, 2023, the entire contents of which are incorporated herein by reference.

### TECHNICAL FIELD

The present application relates to the technical field of anti-settlement and deviation rectification of foundations, and in particular, to a lifting and resetting method for sinking of a deep plant equipment foundation.

### BACKGROUND

In recent years, with the rapid development of the construction engineering industry in China, equipment foundations, as indispensable parts of a project, have also been increasingly widely used. Because some equipment foundations have a series of characteristics such as large diameter, large volume, and large additional stress of the foundations, and if the selected foundation is relatively soft or needs to be backfilled, it is highly likely to cause uneven settlement of the equipment foundation. Once this situation occurs, it will not only seriously delay the project schedule, but also easily lead to property damage and even casualties.

There are many reasons for the uneven settlement of the equipment foundation. In simple terms, they can be classified as external causes and internal causes. The external causes are mainly caused by foundations of a construction site. A series of foundation problems such as the selected foundation being too weak, the soil quality of the foundation being uneven, and foundation backfill soil being not compacted may lead to uneven settlement of the equipment foundation. In addition, factors such as rainfall, earthquakes, and changes in groundwater levels may also cause uneven settlement of the equipment foundation. From a perspective of internal causes, if a load of equipment itself is too heavy and exceeds a design calculation value, or if the arrangement of the equipment foundations is too dense, it is highly likely to cause uneven settlement of the equipment foundations.

Regarding the settlement issue of plant equipment foundations, the commonly used disposal measures include anchor rod static pressure piles, grouting reinforcement and other methods. The existing Chinese patent with Reference Announcement Number CN112343078A discloses a method for precision lifting of a plant equipment foundation. In this patent, the lifting of the plant equipment foundation is implemented through the following three steps: S1, forming curtain walls: drilling holes vertically downward in both sides of the equipment that need to be lifted to form curtain holes, and performing grouting inside the curtain holes to form two curtain walls which are parallel each other; S2, forming a reinforcement body: laying inclined downward grouting holes at an outer contour line of the equipment along a length direction of the curtain walls, performing grouting inside the grouting holes, performing grouting between the two curtain walls at the bottom of an equipment foundation slab to form the reinforcement body that fits the lower surface of the slab, and combining the reinforcement body and the two curtain walls to form a [symbol] -shaped structure; and S3, lifting: with the grouting holes as lifting holes, drilling holes obliquely downward until reaching the bottom of the reinforcement body and being located between the two curtain walls, performing pressure grouting to the bottom of each lifting hole to fill and reinforce the surrounding backfill layer, continuing to pressure grouting, and lifting the equipment to a set lifting height by using backward grouting.

In view of the above-mentioned prior art, the inventors believe that this technology has obvious advantages for shallow settlement and lifting of an equipment foundation, but there is a large demand for grouting materials for deep reinforcement and lifting of the equipment foundation, resulting in material waste.

### SUMMARY

In order to achieve the effects of saving materials and ensuring that a foundation achieves the requirement for permanent settlement stability and deviation rectification for deep reinforcement of the foundation, the present application provides a lifting and resetting method for sinking of a deep plant equipment foundation.

The present application provides a lifting and resetting method for sinking of a deep plant equipment foundation, which adopts the following technical solution:
the lifting and resetting method includes the following steps:
S1, determining a foundation pressure diffusion angle according to a ratio of the compression modulus of a bearing stratum to the compression modulus of a soft underlying stratum, namely ES1/ES2, and a value of Z/b;
S2, determining a diffusion range of a load according to the foundation pressure diffusion angle;
S3, performing grouting reinforcement on an unstable soil body in the soft underlying stratum according to the diffusion range of the load to form grouting reinforcement bodies;
S4, performing grouting reinforcement on the bearing stratum according to the diffusion range of the load, and laying grouting holes in two triangular areas along a direction line of the stress diffusion angle, wherein the grouting holes are distributed on both sides of the equipment foundation;
S5, performing grouting, reinforcing and lifting within a middle range of the bearing stratum; and
S6, constructing irregular composite foundation supporting bodies at the bottom of the soft underlying stratum.

By adopting the above technical solution, a grouting range is determined according to a force transmission mechanism of the load. However, the stress diffusion angle needs to be determined before the determination of the grouting range. When the foundation bears a load from the upper part and transmits the load to the bearing stratum of the foundation, the bearing stratum of the foundation assumes the responsibility of bearing the force and dispersing the force to the crust gradually and evenly. This dispersion mode is diffusion. The law of diffusion causes the range to gradually expand downward at a certain angle. This diffusion angle is the stress diffusion angle, and the magnitude of the stress diffusion angle is determined by step S1. After the grouting range is determined, grouting materials are greatly saved. In addition, the irregular composite foundation supporting bodies are constructed at the lower part of the bearing stratum to provide supporting and anti-settlement effects. In step S5, grouting and lifting within the middle range of the bearing stratum play a role in anti-settlement of the foundation and lifting rectification at the foundation position. The overall technology ultimately achieves the effects of saving materials and ensuring that the foundation achieves the requirement for permanent settlement stability and deviation rectification for deep reinforcement of the foundation.

Optionally, each composite foundation supporting body in step S6 is composed of two inclined grouting channels, and there is an intersection between the two inclined grouting channels.

By adopting the above technical solution, the composite foundation supporting bodies are formed by the way of cross grouting. Firstly, it is convenient to operate and meets the engineering requirements. Secondly, the two grouting channels intersect and then, in combination with the reinforcement bodies formed in step S3, form a stable triangular supporting state ultimately, achieving a stable supporting effect on the upper bearing stratum.

Optionally, a plurality of groups of the composite foundation supporting bodies are provided at intervals.

By adopting the above technical solution, a plurality of groups of composite foundation supporting bodies are arranged to enhance the supporting effect on the upper bearing stratum. This method of interval arrangement also reduces the disturbances between the composite foundation supporting bodies during construction and also the disturbances to the upper foundation.

Optionally, in step S6, secondary reinforcement grouting is carried out on the intersections between the grouting channels after all inclined channels are grouted.

By adopting the above technical solution, secondary reinforcement grouting is carried out on the intersections of the grouting channels, ensuring the stability of force transmission at the intersection position.

Optionally, in step S6, secondary reinforcement grouting is carried out on the intersections between all the grouting channels, and the secondary grouting ranges at the intersections between adjacent grouting channels occlude and overlap each other.

By adopting the above technical solution, the reinforcement bodies formed by the secondary grouting overlap and occlude with each other, so that all the composite foundation supporting bodies form a whole, thereby avoiding the phenomenon where some of the composite foundation supporting bodies settle independently. Once a unified whole is formed, the support for the upper foundation and an anti-settlement effect on the upper foundation are further enhanced.

Optionally, in step S4, a drilling and grouting integrated backward grouting process is adopted, with a section of grouting being carried out after each upward and downward movement.

By adopting the above technical solution, the backward grouting process can be adopted to reduce disturbances to a formation other than the triangular areas, and the backward mode facilitates the extraction of a drill pipe.

Optionally, the reinforcement bodies formed by mutual occlusion and overlap during the secondary grouting at the intersections between adjacent grouting channels are generally in a horizontal state.

By adopting the above technical solution, the reinforcement bodies in the horizontal state present a maximum bearing surface, which can maximize the existence of the reinforcement bodies.

Optionally, the value of Z/b in step S1 is used with a difference ranging from 0.25 to 0.50. Optionally, in step S4, adjacent grouting holes are distributed at intervals.

By adopting the above technical solution, the interval distribution of grouting holes is also to reduce disturbances to other areas other than the triangular areas of the foundation.

Optionally, a vertical projection of the grouting reinforcement bodies formed within the bearing stratum is completely located on the grouting reinforcement bodies formed within the soft underlying stratum.

By adopting the above technical solution, the limitation on the projection of the grouting reinforcement bodies formed within the bearing stratum is to actually limit the area of the grouting reinforcement bodies formed within the soft underlying stratum, enabling the grouting reinforcement bodies formed within the soft underlying stratum to fully provide support to the upper bearing stratum.

In summary, the present application includes at least one of the following beneficial technical effects.
1. The grouting range is determined according to the force transmission mechanism of the load, which greatly saves the grouting materials. The irregular composite foundation supporting bodies are arranged at the lower part of the bearing stratum to solve the settlement problem of the deep plant equipment foundation.
2. The composite foundation supporting bodies in an intersected state, together with the grouting reinforcement bodies formed within the soft underlying stratum, form a stable triangular supporting state, achieving the effects of anti-settlement and stable support on the equipment foundation.

### BRIEF DESCRIPTION OF DRAWINGS

FIG. 1 is a schematic structural diagram of an embodiment of the present application; and

FIG. 2 is a state diagram of the formation of reinforcement bodies in a bearing stratum and a soft underlaying stratum.

Reference symbols represent the following components: 1—ground; 2—grouting pipe; 3—foundation; 4—bearing stratum; 5—soft underlying stratum; and 6—composite foundation supporting body.

### DETAILED DESCRIPTION OF THE EMBODIMENTS

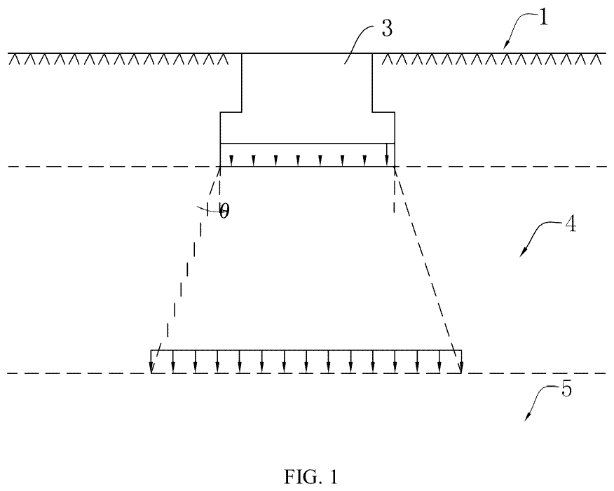

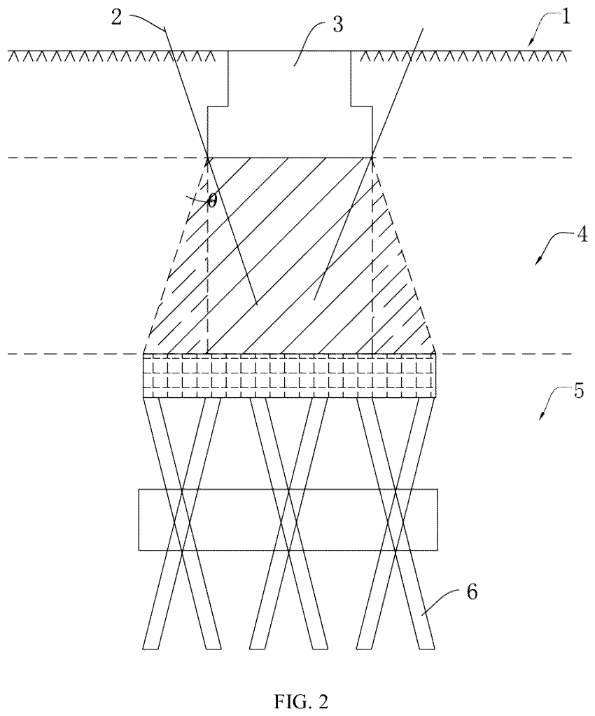

The present application will be further described in detail below with reference to FIGS. 1-2.

An embodiment of the present application discloses a lifting and resetting method for sinking of a deep plant equipment foundation.

Referring to FIG. 1 and FIG. 2, a lifting and resetting method for sinking of a deep plant equipment foundation includes the following steps:

S1, determining a foundation pressure diffusion angle, i.e., θ, according to a ratio of the compression modulus of a bearing stratum 4 to the compression modulus of a soft underlying stratum 5, namely ES1/ES2, and a value of Z/b. The stress diffusion angle needs to be determined before the determination of the grouting range. When the foundation 3 bears a load from the upper part and transmits the load to the bearing stratum 4 of the foundation, the bearing stratum 4 of the foundation assumes the responsibility of bearing the force and dispersing the force to the crust gradually and evenly. This dispersion mode is diffusion. The law of diffusion causes the range to gradually expand downward at a certain angle. The foundation pressure diffusion angle is determined according to the “Code for Design of Ground Base and Foundation”.

Foundation pressure diffusion angle:

Z/b

| ES1/ES2 | 0.25 | 0.50 |
|---|---|---|
| 3 | 6° | 23° |
| 5 | 10° | 25° |
| 10 | 20° | 30° |

ES1 represents the compression modulus of upper soil; ES2 represents the compression modulus of lower soil; Z represents the depth of a calculation point from a base; and b represents the width of a foundation base surface.

When Z/b<0.25, θ=0° should be taken. If necessary, it should be determined by test. When Z/b>0.50, a value of θ remains unchanged.

The value of Z/b is used with a difference ranging from 0.25 to 0.50. If ES1/ES2 is 3, Z/b is calculated to be 0.375, and then, the corresponding value of θ is 14.5°.

S2, determining a diffusion range of a load according to the foundation pressure diffusion angle. According to the value of θ, it extends downward to the soft underlying stratum 5, and an area spanning the entire bearing stratum 4 is a range where the load is transmitted and diffused.

S3, performing grouting reinforcement on an unstable soil body in the soft underlying stratum 5 according to the diffusion range of the load to form grouting reinforcement bodies.

S4, performing grouting reinforcement on the bearing stratum 4 according to the diffusion range of the load, and laying grouting holes in two triangular areas along a direction line of the stress diffusion angle, wherein the grouting holes are distributed on both sides of the equipment foundation 3. During grouting, a drilling and grouting integrated backward grouting process is adopted, with a section of grouting being carried out after each upward and downward movement. After grouting is completed, it needs to be ensured that a vertical projection of the grouting reinforcement bodies formed within the bearing stratum 4 is completely located on the grouting reinforcement bodies formed within the soft underlying stratum 5.

S5, performing grouting, reinforcing and lifting within a middle range of the bearing stratum 4.

S6, constructing irregular composite foundation supporting bodies 6 at the bottom of the soft underlying stratum 5. Each composite foundation supporting body 6 is composed of two inclined grouting channels, and there is an intersection between the two inclined grouting channels. The two inclined grouting channels are mutually intersected into a group. A plurality of groups of the composite foundation supporting bodies 6 are provided at intervals. Secondary reinforcement grouting is carried out on the intersections between the grouting channels after all inclined channels are grouted. The secondary grouting ranges at the intersections between adjacent grouting channels occlude and overlap each other. It is ensured that the reinforcement bodies formed by mutual occlusion and overlap during the secondary grouting at the intersections between adjacent grouting channels is generally are a horizontal state.

By adopting this method, reinforcement and lifting are performed on deep settlement of independent foundations and strip foundations. Compared with conventional composite piles, the composite foundation supporting bodies 6 achieve more uniform force transmission, so that the upper load can be transmitted more evenly to a deeper soil layer. Secondary reinforcement grouting is carried out on the intersections between the grouting channels after all inclined channels are grouted, which ensures stable force transmission at the intersection position, achieves the requirement for permanent settlement stability for the equipment foundation 3 and also achieves the purpose of deviation rectification for the equipment foundation 3.

The embodiments in the detailed description are preferred embodiments of the present application and are not intended to limit the protection scope the present application. Therefore, any equivalent changes made in accordance with the structure, shape and principle of the present application shall fall within the protection scope of the present application.

What is claimed is:

1. A lifting and resetting method for sinking of a deep plant equipment foundation, comprising the following steps:
S1, determining a foundation pressure diffusion angle according to a ratio of the compression modulus of a bearing stratum (4) to the compression modulus of a soft underlying stratum (5), namely ES1/ES2, and a value of Z/b;
S2, determining a diffusion range of a load according to the foundation pressure diffusion angle;
S3, performing grouting reinforcement on an unstable soil body in the soft underlying stratum (5) according to the diffusion range of the load to form grouting reinforcement bodies;
S4, performing grouting reinforcement on the bearing stratum (4) according to the diffusion range of the load, and laying grouting holes in two triangular areas along a direction line of the stress diffusion angle, wherein the grouting holes are distributed on both sides of the equipment foundation (3);
S5, performing grouting, reinforcing and lifting within a middle range of the bearing stratum (4); and
S6, constructing irregular composite foundation supporting bodies (6) at the bottom of the soft underlying stratum (5).

2. The lifting and resetting method for sinking of a deep plant equipment foundation according to claim 1, wherein each composite foundation supporting body (6) in step S6 is composed of two inclined grouting channels, and there is an intersection between the two inclined grouting channels.

3. The lifting and resetting method for sinking of a deep plant equipment foundation according to claim 2, wherein a plurality of groups of the composite foundation supporting bodies (6) are provided at intervals.

4. The lifting and resetting method for sinking of a deep plant equipment foundation according to claim 3, wherein in step S6, secondary reinforcement grouting is carried out on the intersections between the grouting channels after all inclined channels are grouted.

5. The lifting and resetting method for sinking of a deep plant equipment foundation according to claim 4, wherein in step S6, secondary reinforcement grouting is carried out on the intersections between all the grouting channels, and the secondary grouting ranges at the intersections between adjacent grouting channels occlude and overlap each other.

6. The lifting and resetting method for sinking of a deep plant equipment foundation according to claim 1, wherein in step S4, a drilling and grouting integrated backward grouting process is adopted, with a section of grouting being carried out after each upward and downward movement.

7. The lifting and resetting method for sinking of a deep plant equipment foundation according to claim 5, wherein
the reinforcement bodies formed by mutual occlusion and overlap during the secondary grouting at the intersections between adjacent grouting channels are generally in a horizontal state.

8. The lifting and resetting method for sinking of a deep plant equipment foundation according to claim 1, wherein the value of Z/b in step S1 is used with a difference ranging from 0.25 to 0.50.

9. The lifting and resetting method for sinking of a deep plant equipment foundation according to claim 1, wherein in step S4, adjacent grouting holes are distributed at intervals.

10. The lifting and resetting method for sinking of a deep plant equipment foundation according to claim 1, wherein a vertical projection of the grouting reinforcement bodies formed within the bearing stratum (4) is completely located on the grouting reinforcement bodies formed within the soft underlying stratum (5).
